(19) United States
(12) Patent Application Publication
(10) Pub. No.: US 2003/0207039 A1
(43) Pub. Date: Nov. 6, 2003

(54) Method of manufacturing golf ball

(75) Inventors: Masatoshi Takahashi, Hyogo (JP); Hideki Sano, Hyogo (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 10/407,457

(22) Filed: Apr. 7, 2003

Related U.S. Application Data
(63) Continuation of application No. 09/518,197, filed on Mar. 3, 2000, now abandoned.

(30) Foreign Application Priority Data
Mar. 5, 1999 (JP) 11-58496

(51) Int. Cl. B05D 3/02

(52) U.S. Cl. 427/385.5

(57) ABSTRACT

A main agent containing polyol and a hardening agent containing polyisocyanate are mixed with each other to form a two liquid type urethane paint. Immediately after the mixing of the two agents is completed, the two liquid type urethane paint is applied to the surface of the body of a golf ball. The primer treatment of the surface of the body of the golf ball is not made. The two liquid type urethane paint is applied to the body surface of the golf ball within 20 minutes after the main agent and the hardening agent are mixed with each other. The main agent includes urethane polyol.

### BACKGROUND OF THE INVENTION

1. Field of the Invention

Generally, the present invention relates to a method of manufacturing a golf ball and more particularly, to a method of manufacturing a golf ball including a process of applying a urethane paint, in which two liquid agents are mixed and reacted (in thereafter, two-liquid type urethane paint is called for short.), to the surface of the body of the golf ball.

2. Description of the Related Art

To protect the body of the golf ball and improve its appearance, paint is applied to the surface of the body to form a coating film thereon. While the golf ball is repeatedly hit with a golf club, an impact applied thereto causes its body to deform to a maximum of about 30%. Following the deformation of the body, the coating film deforms. If the coating film is adhesive to the body insufficiently or too hard and has an insufficient elasticity, the coating film cannot follow the deformation of the body and separates from the surface of the body. Further, because the head of the golf club has a loft, the face of the golf ball is rubbed with the golf ball club head, when the golf ball is hit with a golf club. Therefore, if the coating film is brittle or soft, it is scratched.

As the paint, which is applied to the surface of the body of the golf ball to form a coating film, not easily separating from the body of the golf ball (adhesive property) and not easily scratched (mar resistance), a two liquid type urethane paint consisting of a main agent containing polyol and a hardening agent containing polyisocyanate is used. When the two liquid type urethane paint formed by mixing the main agent and the hardening agent with each other is applied to the surface of the body of the golf ball, the polyol and the polyisocyanate react with each other to form urethane bonds that harden the coating film. To accelerate the hardening reaction, it is necessary to store the painted golf ball in a high-temperature environment.

As the material of the cover of the golf ball, synthetic resin such as ionomer resin is mostly used. As the material of the core thereof, rubber (thread rubber, solid rubber) is mostly used. If a golf ball-storing temperature is set very high to accelerate the hardening of the coating film, the synthetic resin and the rubber will deteriorate, the golf ball will have a low durability and repulsion coefficient and thus a short flight distance. Therefore, the golf ball-storing temperature cannot be set very high, and hence the time period required for the hardening reaction (hereinafter referred to as “drying time”) is necessarily long. For example, in an ordinary golf ball-manufacturing factory, the coating film is hardened at a temperature in the range from 30° C. to 40° C. for more than 20 hours. A long drying time period causes the productivity of the golf ball to deteriorate.

There is proposed a two liquid type urethane paint containing urethane polyol as its main agent to increase the productivity of the golf ball as disclosed in Japanese Patent Application Laid-Open No. 9-59566. The urethane polyol is urethanated by the pre-reaction of a part of hydroxyl groups of the polyol with isocyanate groups thereof. In the two liquid type urethane paint, before the main agent and the hardening agent are mixed with each other, the urethane bond is present in the main agent to some extent. Thus, a short period of time is required for the urethanated reaction after the main agent and the hardening agent are mixed with each other, which shortens the drying time period.

However, the two liquid type urethane paint containing the urethane polyol has a smaller number of free hydroxyl groups in its main agent and a smaller number of free isocyanate groups in the hardening agent than normal paint. Thus, the two liquid type urethane paint is insufficiently reactive on the surface of the body of the golf ball. Therefore, the coating film has a low degree of adhesion to the surface of the body of the golf ball.

Primer treatment is proposed as a means for enhancing the adhesion of the coating film consisting of the two liquid type urethane paint to the surface of the body of the golf ball. For example, in Japanese Patent Application Laid-Open No. 10-165886, there is disclosed a primer treatment method of priming the body of the golf ball by using a surface treatment agent (primer solution) containing a particular silane coupling agent as its main component. The primer treatment is carried out by immersing the body of the golf ball in the primer solution.

The primer solution has property of absorbing water content of a peripheral atmosphere. The primer solution also absorbs water content owing to heat of vaporization caused by the vaporization of a primer solvent. Thus, while the primer treatment is repeatedly made, the primer solution contains the water content. For example, when 500 dozens of golf balls are treated with the primer solution in about an hour in an ordinary factory, the primer solution contains about 1 wt % of water content. After 1000 dozens of golf balls are treated with the primer solution, the primer solution contains about 3 wt % of water content. The adhesion of the coating film to the surface of the body of the golf ball that has undergone the primer treatment is reduced by the water content of the primer solution. To prevent the deterioration of the adhesion of the coating film to the surface of the body of the golf ball, it is necessary to prepare and replace the primer solution frequently and discharge waste liquor frequently, which leads to deteriorated productivity. Moreover, a large amount of waste liquor is generated as a result of the replacement of the primer solution.

The problem of the deterioration of the productivity does not occur if the primer treatment is not performed. But without treating the body of the golf ball with the primer, the coating film has a low degree of adhesion to the surface of the body of the golf ball, as described above. That being the case, the primer treatment is unavoidably executed by replacing the primer solution frequently.

### SUMMARY OF THE INVENTION

The present invention has been made in view of the above-described problem. Thus, it is an object of the present invention to provide a method of manufacturing a golf ball allowing primer treatment to be omitted without deteriorating the adhesion of a coating film to the surface of the body of the golf ball, namely, to provide a method of manufacturing a golf ball with a high productivity.

Owing to the energetic investigation of the present inventors, they have found that even though primer treatment of the surface of the body of the golf ball is not performed, a two liquid type urethane paint that forms a coating film on the surface of the body of the golf ball maintains its adhesion thereto, provided that the two liquid type urethane paint is used within a specific time period after a main agent and a hardening agent of the two liquid type urethane paint are mixed with each other.

According to the present invention, there is provided a method of manufacturing a golf ball including an coating process of applying a two liquid type urethane paint consisting of a main agent containing polyol and a hardening agent containing polyisocyanate to the surface of the body of the golf ball, where in that the two liquid type urethane paint is applied to the body surface of the golf ball immediately after the main agent and the hardening agent are mixed with each other, without performing primer treatment of the body surface of the golf ball.

In the manufacturing method, the primer treatment of the surface of the body of the golf ball is not performed. Thus, it is unnecessary to replace a primer solution, which does not lead to deteriorated productivity of the golf ball and nor the generation of a large amount of a waste liquor. Further, the two liquid type urethane paint is applied to the surface of the body of the golf ball immediately after the main agent and the hardening agent are mixed with each other. Thus, there is no deterioration in the adhesion of the coating film to the surface of the body of the golf ball. Although the reason the adhesion of the coating film does not deteriorate has not been clarified in detail, it is assumed that by applying the two liquid type urethane paint to the surface of the body of the golf ball immediately after the main agent and the hardening agent are mixed with each other, reaction occurs between a reactive group such as a carboxyl group of a substance forming the surface of the body of the golf ball and a hydroxyl group an isocyanate group contained in the two liquid type urethane paint, simultaneously with occurrence of a urethanated reaction or prior to the occurrence of the urethanated reaction.

According to the present invention, the time period in which the two liquid type urethane paint is used is limited to less than 20 minutes after its main and hardening agents are mixed with each other. The time period in which the two liquid type urethane paint is used is favorably less than 10 minutes and more favorably less than three minutes after its main and hardening agents are mixed with each other. If the time period in which the two liquid type urethane paint is used is over 20 minutes, the urethanated reaction proceeds before the two liquid type urethane paint is applied to the surface of the body of the golf ball and thus the main agent lacks in free hydroxyl groups, and the hardening agent lacks in free isocyanate groups. Consequently, the two liquid type urethane paint may have a deteriorated adhesion to the surface of the body of the golf ball. Because it is preferable to apply the two liquid type urethane paint to the surface of the body of the golf ball as soon as possible after its main and hardening agents are mixed with each other, it is unnecessary to set an earliest use time of the two liquid type urethane paint.

According to the present invention, the polyol serving as the main agent of the two liquid type urethane paint includes urethane polyol. In the two liquid type urethane paint, the urethane bond is present in its main agent to some extent before its main and hardening agents are mixed with each other. Thus, a short period of time is required for the urethanated reaction after the main agent and the hardening agent are mixed with each other, which shortens the drying time period. Although the two liquid type urethane paint has a small number of free hydroxyl groups and free isocyanate groups therein, the two liquid type urethane paint can be allowed to sufficiently react with the substance forming the surface of the body of the golf ball by applying the two liquid type urethane paint thereto immediately after its main agent and hardening agents are mixed with each other. Therefore, the coating film has a high degree of adhesion to the surface of the body of the golf ball. Accordingly, the manufacturing method of the present invention has a high productivity and allows the coating film to have high degree of adhesion to the surface of the body of the golf ball.

According to the present invention, it is preferable to use a two liquid type urethane paint satisfying the following condition: Immediately after the main agent and the hardening agent are mixed with each other, it takes 12 minutes to 37 minutes, favorably 30 minutes to 35 minutes, for a drop time period (JIS-k-5400) of the two liquid type urethane paint to become one second slower than a drop time period thereof at a time immediately after the main agent and the hardening agent are mixed with each other. If the drop time period is less than 12 minutes, the hardening speed is too fast, which may lead to hardening of the two liquid type urethane paint in a mixing device. On the other hand, if the drop time period is more than 37 minutes, the hardening speed is too slow. In this case, the effect of the present invention is not displayed.

Various golf balls can be manufactured by the manufacturing method of the present invention. The present invention is particularly applicable to a golf ball having a cover containing ionomer resin as its main component. The carboxyl group is present in the ionomer resin. By applying the present invention to the golf ball whose cover contains the ionomer resin as its main component, it is possible to accelerate the reaction of the carboxyl group with the hydroxyl group and the isocyanate group, thus, enhance the adhesion of the coating film to the surface of the body of the golf ball.

### DETAILED DESCRIPTION OF THE PREFERRED EMBODIMENTS

The golf ball that is manufactured by the manufacturing method of the present invention includes a one-piece golf ball whose body consists of solid rubber, a thread wound golf ball having a core wound by thread rubber and covered with a cover, a two-piece golf ball having a cover and a solid core covered with the cover, and a multi-piece golf ball having a cover and a solid core of two or more layers covered with the cover. Before the process of coating the two liquid type urethane paint to the surface of the body of the golf ball, the body of each of these golf balls undergoes pre-treatment such as surface polishing, shot blast treatment, framing treatment, and cleaning with a solvent. The two liquid type urethane paint is coated to the surface of the body of the golf ball without performing the primer treatment. As the coating method, it is possible to adopt known methods such as air spray gun method, electrostatic deposition method or the like. After the coating film is dried, marking and clear paint are applied thereto as necessary to complete the manufacture of the golf ball.

The two liquid type urethane paint that is used in the coating process consists of the main agent containing the polyol and the hardening agent containing the polyisocyanate. The ratio of the equivalent weight (NCO/OH) of the isocyanate group of the hardening agent to the hydroxyl group of the main agent is normally 0.5 to 2.0.

Any kinds of polyols can be used as the main agent provided that they have a plurality of hydroxyl groups. The following substances can be used as the main agent: diols such as ethylene glycol, diethylene glycol, triethylene glycol, butylene glycol, 1,3-butanediol, 1,4-butanediol, neopentyl glycol, and 1,6-hexanediol; triols such as glycerin, trimetyrolpropane, hexanetriol; polyether polyol (for example, polyethylene glycol, polypropylene glycol, polytetramethylene glycol) that is obtained by the reaction of a starting agent having an active hydrogen and alkylene oxide; condensation polyester polyol (for example, polyethylene adipate) obtained by dehydration condensation of dibasic acid such as adipic acid and glycol or triol; lactone polyester polyol (for example, poly-ε-caprolactone) obtained by ring opening polymerization of lactam such as ε-caprolactam; polycarbonate diol synthesized by using cyclic diol; and polymer polyol such as acrylic polyol having a hydroxyl group introduced into acrylic copolymer. These polyols are used singly or in combination of two or more of the above substances.

Any substances containing a plurality of the isocyanate groups can be used as the polyisocyanate serving as the hardening agent. For example, it is possible to use diisocyanate compounds of aliphatic series, alicyclic series, aromatic series, and aromatic aliphatic series. More specifically, hexamethylene diisocyanate, xylylene diisocyanate, hydrogenated xylylene diisocyanate, isophorone diisocyanate, tetramethylxylylene diisocyanate, and hydrogenated diphenylmethane diisocyanate. These polyisocyanate are used singly or in the form of a mixture of two or more of the above substances.

As the main agent of the two liquid type urethane paint of the present invention, urethane polyol is preferably used because it shortens the drying time. In the urethane polyol, the polyol and the polyisocyanate react with each other to form a urethane bond having the hydroxyl group at both ends thereof. As the polyol to form the urethane polyol, the above-described polyols are used. As the polyisocyanate to form the urethane polyol, the above-described polyisocyanates are used.

The ratio of the urethane bond to 1 g of the urethane polyol is preferably 0.1 millimoles to 3 millimoles. If the ratio is less than 0.1 millimoles, the coating film may have a low mar resistance. On the other hand, if the ratio is more than five millimoles, the coating film may have a low adhesion.

The molecular weight on the weight-average of the urethane polyol is favorably 4000 to 10000 and more favorably 4500 to 9000. If the molecular weight is less than 4000, the drying time period is long, which may deteriorate the productivity of the golf ball. On the other hand, if the molecular weight is more than 10000, the urethane polyol has a relatively low hydroxyl value, and the amount of reaction of the urethane polyol with the hardening agent is small after the two liquid type urethane paint is applied to the surface of the body of the golf ball. As a result, the coating film has a low adhesion to the surface of the body of the golf ball.

The hydroxyl value or the urethane polyol is favorably 15 mgKOH/g to 130 mgKOF/g and more favorably 73 mgKOH/g to 120 mgKOF/g. If the hydroxyl value is less than 15 mgKOH/g, the amount of the reaction of the urethane polyol with the hardening agent is small, which may cause the coating film to have a low adhesion to the surface of the body of the golf ball. On the other hand, if the hydroxyl value is more than 130 mgKOH/g, the drying time is long, which may cause the productivity of the golf ball to deteriorate and the coating film to crack.

The urethane polyol is formed by synthesis as follows: The polyol is diluted with a solvent, and an isocyanate compound is added gradually to the mixture in the presence of reaction catalyst such as dibutyltin dilaurate while the mixture is being stirred to form the urethane bond. The ratio of the urethane bond to the urethane polyol is determined by adjusting the mixing ratio between the polyol and the polyisocyanate.

As described above, the urethane polyol is preferably used as the polyol serving as the main agent of the two liquid type urethane paint. However, other polyols may be mixed with the urethane polyol to form the main agent. In this case, the mixing ratio of the urethane polyol to the main agent is favorably 50 wt % or more and more favorably more than 80 wt % to shorten the drying time period.

The distinctive characteristic of the present invention is that in the two liquid type urethane paint coating process, the two liquid type urethane paint is applied to the body surface of the golf ball immediately after the main agent and the hardening agent are mixed with each other. To apply the two liquid type urethane paint to the surface of the body of the golf ball immediately after the main agent and the hardening agent are mixed with each, it is conceivable to intermittently apply the two liquid type urethane paint thereto by mixing the main agent and the hardening agent with each other little by little. But in view of the productivity of the golf ball, it is preferable to use air spray gun using a two-liquid constant-ratio pump. That is, two liquids are successively mixed with each other with a line mixer (for example, static mixer) provided on a paint delivery path such that the line mixer is disposed immediately before an air spray gun. According to this method, all the two liquid type urethane paint can be used in two-three minutes after mixing the main agent and the hardening agent with each other. As another similar method, an air spray system having a mixing ratio control mechanism can be used.

(EXAMPLE)

Bifunctional polyol consisting of “PTMG650” manufactured by BASF Inc. and trifunctional polyol consisting of trimethylolpropane manufactured by Koei Kagaku Inc. were mixed with each other at a ratio shown in table 1 shown below. Then, the mixture was diluted with toluene serving as a solvent such that the solid content of the polyol was 30% Then, 0.02% of dibutyltin dilaurate was added to the mixture as catalyst. In this manner, a main agent was prepared. While, hexamethylene diisocyanate “N3500” manufactured by Sumitomo Bayer Inc. was diluted with toluene serving as a solvent such that the solid content of the hexamethylene diisocyanate was 60%. In this manner, a hardening agent was prepared.

In above process, a two liquid type urethane paint containing the main agent consisting of the urethane polyol and the hardening agent consisting of the hexamethylene diisocyanate was obtained.

TABLE 1

| | E1 | E2 | E3 | E4 | E5 | E6 | E7 |
|---|---|---|---|---|---|---|---|
| Trifunctional | 1.0 | 1.2 | 1.5 | 1.8 | 2.3 | 1.5 | 1.5 |
| polyol/bifunctional | | | | | | | |
| polyol | | | | | | | |

Where E1 is a first example, E2 is a second example, and the like.

Measuring the drop time period of the two liquid type urethane paint in accordance with JIS-K-5400 (ford cup of SUS304 was used) at the time immediately after the two liquid type urethane paint was formed by mixing the main agent and the hardening agent with each other, it was 10.5 seconds. Immediately after the main agent and the hardening agent were mixed with each other, 28 minutes elapsed until the drop time period of the two liquid type urethane paint became one second slower than 10.5 seconds.

(Method of Manufacturing Golf Ball without Performing Primer Treatment)

Initially, a rubber composition consisting of 100 parts by weight of 1,4-cispolybutadiene (trade name: “BR01” manufactured by Nippon Gosei Gomu Inc.), 22 parts by weight of zinc oxide, 25 parts by weight of zinc acrylate, and one part by weight of dicumyl peroxide was vulcanized in a mold at a vulcanizing temperature of 150° C. for 15 minutes. As a result, a solid core having a diameter of 38. 3 mm and a weight of 34.9 g was obtained. Then, using a resin composition consisting of 100 parts by weight of ionomer resin (trade name: “Highmilan 1605” manufactured by Mitsui Dupon Chemical Inc.) and two liquid types by weight of titanium oxide, a cover was formed in a thickness of 2.3 mm on the periphery of the solid core by injection molding method. The body of a golf ball thus obtained had a diameter of 42.7 mm and a weight of 45. 3 g.

After surface treatment such as shot blast was made on the surface of the body of the golf ball, the two liquid type urethane paint was coated to the surface of the body of the golf ball with an air spray gun. The coating film was dried at 40° C. for one hour. The time period required from the time at which the main agent and the hardening agent were mixed with each other until the time at which the two liquid type urethane paint was applied the surface of the body of the golf ball was varied as shown in table 2.

(Method of Manufacturing Golf Ball by Performing Primer Treatment)

Golf balls were manufactures by the above-described method except that the primer treatment was made before two liquid type urethane paint was applied to the surface of the body thereof. The primer treatment was conducted by using a primer solution (liquid temperature was 20° C.) diluted with isopropyl alcohol such that the content of epoxy aminosilane treating agent (trade name: KBP-43 manufactured by Shinetsu Kagaku Kogyo Inc.) was 0.15 wt %. The body of each golf ball was immersed in the primer solution for one minute. After, the body was dried at 38° C. for one hour. The deposition amount of the primer solution on the surface of the body of the golf ball was about 15 nanometers, when the solid content was calculated in terms of a film thickness.

(Test of Adhesion of Coating Film)

Golf balls manufactured by the above-described two manufacturing methods were immersed in water at the normal temperature for 24 hours. Then, a test of colliding each golf ball with a metal plate at a speed of 45 m/sec was conducted. The state of the surface of each golf ball was visually observed after it collided with the metal plate 100 times. The golf balls were classified into three groups ◯, Δ, and x according to the degree of separation of the coating film from the surface of the body thereof. ◯ indicates the golf ball having the coating film not separated from the surface of the body thereof. Δ indicates the golf ball having the coating film separated from the surface of the body thereof to some extent. x indicates the golf ball having the coating film separated from the body thereof to a high extent. The evaluated result is shown in table 2 below.

TABLE 2

| | | | | | | | | |
|---|---|---|---|---|---|---|---|---|
| Elapsed | 1 m | 5 m | 10 m | 15 m | 20 m | 25 m | 30 m | 35 m |
| time after | | | | | | | | |
| mixing | | | | | | | | |
| Primer | ∘ | ∘ | ∘ | ∘ | ∘ | Δ | x | x |
| treatment | | | | | | | | |
| not made | | | | | | | | |
| Primer | ∘ | ∘ | ∘ | ∘ | ∘ | ∘ | ∘ | ∘ |
| treatment | | | | | | | | |
| made | | | | | | | | |

Where “m” of 1 m and the like is minute.

As indicated in table 2, when 25 minutes or more passed after the main agent and the hardening agent were mixed with each other, the golf ball which did not undergo the primer treatment was inferior to the golf ball which underwent the primer treatment in the adhesion of the coating film to the surface of the body thereof. However, within 20 minutes after the mixing of the main agent and the hardening agent, the golf ball which did not undergo the primer treatment was almost equal to the golf ball which underwent the primer treatment in the adhesion of the coating film to the surface of the body thereof. It was confirmed that by coating the two liquid type urethane paint to the body surface of the golf ball immediately after the main agent and the hardening agent are mixed with each other, the coating film maintains its adhesion to the surface of the body of the golf ball even though primer treatment of the surface of the body of the golf ball is not performed.

As apparent from the foregoing description, the manufacturing method of the present invention allows the primer treatment to be omitted without deteriorating the adhesion of the coating film to the surface of the body of the golf ball. That is, according to the manufacturing method, the golf ball can be manufactured with a high productivity. Further, because the primer treatment is not made, it is possible to prevent the surface of the body of the golf ball from turning yellow.

1. A method of manufacturing a golf ball which comprises the step of coating a body surface of the golf ball with a urethane coating paint composition consisting essentially of a urethane polyol and a polyisocyanate as a hardening agent, wherein the paint composition is applied to the body surface of the golf ball in the absence of water and in the absence of primer treatment on the body surface.

2. The method of manufacturing a golf ball according to claim 1, wherein at least a single coat of said two liquid component urethane paint is applied to said body surface of said golf ball without any primer treatment immediately after said polyol and the polyisocyanate hardening agent are mixed with each other.

3. The method of manufacturing a golf ball according to claim 2, wherein, it takes 12 minutes to 37 minutes for a drop time period (JIS-K-5400) of said two liquid component urethane paint to become one second slower than a drop time period thereof at a time immediately after said main agent and said hardening agent are mixed with each other.

4. The method of manufacturing a golf ball according to claim 3, wherein, it takes 12 minutes to 37 minutes for a drop time period (JIS-k-5400) of said two liquid component urethane paint to become one second slower than a drop time period thereof at a time immediately after said main agent and said hardening agent are mixed with each other.

5. The method of manufacturing a golf ball according to claim 2, wherein said golf ball has a cover containing ionomer resin before the two liquid component urethane paint is applied.

6. The method of manufacturing a golf ball without primer treatment according to claim 3, wherein said golf ball has a cover containing ionomer resin.
